(19) United States
(12) Patent Application Publication
(10) Pub. No.: US 2007/0015015 A1
(43) Pub. Date: Jan. 18, 2007

(54) Solid oxide fuel cell

(76) Inventors: Koji Hoshino, Chiyoda-ku (JP); Norihisa Chitose, Chiyoda-ku (JP); Takashi Yamada, Chiyoda-ku (JP); Norikazu Komada, Chiyoda-ku (JP); Kazunori Adachi, Chiyoda-ku (JP); Kei Hosoi, Chiyoda-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/178,280

(22) Filed: Jul. 12, 2005

(51) Int. Cl. H01M 8/06; H01M 8/12; H01M 4/86

(52) U.S. Cl. 429/19; 429/34; 429/30; 429/40

(57) ABSTRACT

An object of the present invention is to provide a solid oxide fuel cell assembled with an internal reforming mechanism stable and efficient over a long period. To achieve the object, in the present invention, a fuel-electrode layer 3 and an air-electrode layer 4 are disposed on both surfaces of a solid electrolyte layer 2; a fuel-electrode-side porous metal 6 and an air-electrode-side porous metal 7 are disposed on the outer surfaces of the fuel-electrode layer 3 and the air-electrode layer 4, respectively; and a separator 8 is disposed on each of the outer surfaces of the fuel-electrode-side porous metal 6 and the air-electrode-side porous metal 7. Then, the solid oxide fuel cell is constructed by closely adhering them all. The pores 6a in the fuel-electrode-side porous metal 6 is partially or fully filled with a hydrocarbon reforming catalyst 10, and reforming reaction is driven by the reforming catalyst 10 before a fuel gas reaches the fuel-electrode layer 3.

### BACKGROUND OF THE INVENTION

1. Field of the Invention

The present invention relates to solid oxide fuel cells having a structure in which a porous metal is interposed between a separator and an electrode layer and more particularly to an internal reforming mechanism of solid oxide fuel cells.

2. Description of the Related Art

The solid oxide fuel cell (SOFC) is being developed as a third-generation fuel cell for power generation. For such solid oxide fuel cells, three types of tubular, monolithic and planar designs are now proposed, any of which has a laminate structure in which a solid electrolyte composed of an oxide ionic conductor is interposed between an air-electrode layer (cathode) and a fuel electrode layer (anode). Power generating cells composed of the laminate, and separators are stacked alternately by a plurality of numbers, with a fuel-electrode current collector or an air-electrode current collector correspondingly interposed therebetween, to constitute a fuel cell stack of high output.

In the solid oxide fuel cell, an oxidant gas (oxygen or air) is fed to the air-electrode layer side, and a fuel gas (H₂, CO, CH₄, etc.) to the fuel-electrode layer side as reactant gases. The air-electrode layer and the fuel-electrode layer are both made to be a porous layer so that the reactant gases can reach the interfaces with the solid electrolyte layer.

An electrode reaction in the solid oxide fuel cell when hydrogen is used as the fuel is as follows.

Oxygen fed to the air-electrode layer reaches near the interface with the solid electrolyte layer through pores in the air-electrode layer, and receives there electrons from the air-electrode layer to be ionized to oxide ions (O²⁻). The oxide ions diffusively migrate in the solid electrolyte layer to the fuel-electrode layer. The oxide ions which have reached near the interface with the fuel-electrode layer react here with the fuel gas to form reaction products (H₂O) and release electrons to the fuel-electrode layer. The electrons are taken out as an electromotive force by an external load on another route.

Here, the electrode reaction when hydrogen is used as a fuel is as follows.
Air-electrode: ½O₂+2e⁻→O²⁻
Fuel-electrode: H₂+O²⁻→H₂O+2e⁻
Overall: H₂+½O₂ →H₂O

A hydrocarbon compound (referred to as a raw fuel) such as methane gas is commonly employed as a fuel gas for a solid oxide fuel cell. Therefore, the raw fuel practically needs to be reformed for use into a fuel gas composed mainly of hydrogen. The reforming method is, in the case where the raw fuel is a hydrocarbon-based gaseous or liquid fuel, generally a steam reforming.

For example, reforming reaction using methane gas as a raw fuel is as follows.

A desulfurized methane gas is mixed with steam in a reformer to be reformed into hydrogen and carbon monoxide. Since reforming reaction is an endothermic one, a high temperature of about 650 to 800° C. is needed to perform a stable reforming reaction.
CH₄+H₂O→3H₂+CO

At this time, the formed carbon monoxide further reacts with steam to be converted into hydrogen and carbon dioxide.
CO+H₂O→H₂+CO₂

As fuel gas reforming methods for the solid oxide fuel cell conventionally known are an external reforming method where a reformer is externally installed and an internal reforming method where a reforming mechanism is incorporated inside a high-temperature fuel cell module.

The external reforming method is one in which the reformer containing a hydrocarbon reforming catalyst is installed outside the fuel cell, and reforms the raw fuel, and in which the resulting reformed gas is introduced into the fuel cell. Since reforming reaction is an endothermic one, the method needs to supply heat at a high temperature for reforming reaction to the external reformer and needs a wasteful energy to obtain the high temperature heat, and has a problem that the power generating system efficiency is correspondingly reduced.

On the other hand, the internal reforming method is a very rational one where a part of the heat generated in the power generating reaction of the fuel cell is utilized for the endothermic reaction of reforming, and has a possibility of achieving a highly efficient system. The method has additionally a cooling effect of the endothermic reaction to absorb the exhaust heat at a high temperature generated in the power generation, so it has been recently focused on as a reforming method for a solid oxide fuel cell.

However, the conventional solid oxide fuel cells which employ the internal reforming method described above have problems that the endothermic reaction generates an inhomogeneous temperature distribution in the power generating cells, and the thermal stress due to that causes degradation and breakage of the power generating cells, and the local temperature decrease causes reduction of the cell performance. As methods to eliminate such problems known are those disclosed in, for example, Japanese Patent Laid-Open No. 06-349504 and Japanese Patent Laid-Open No. 05-325996, any of which has problems to be solved in durability and stability of power generating performance of the fuel cell.

Besides, the conventional solid oxide fuel cells which employ the internal reforming method described above have problems that Ni in the fuel-electrode layer is degraded under the influence of CO gas formed in the reforming process and H₂S gas and the like formed from sulfur contained in the raw fuel in reforming, and carbon deposited from the raw fuel is adhered to Ni in the fuel-electrode layer, thereby causing premature decrease in the power generating performance of the power generating cell.

On the other hand, with progress in research and development of solid oxide fuel cells in recent years, a solid oxide fuel cell of a low-temperature type operating at a temperature of about 700° C. is proposed, instead of a high-temperature type operating at a temperature of about 1000° C.

The high-temperature operating type can easily obtain a high temperature required for reforming, but such low-temperature operating type cannot provide a sufficient reforming capability for an internal reformer because the temperature in the fuel cell module becomes 600° C. or less and falls below an optimal reforming temperature. When an insufficiently reformed fuel gas containing excess methane as an ingredient is introduced in a fuel cell stack and reaches its fuel-electrode layer, the carbon deposition from methane occurs, and a problem of a rapid decrease in the cell performance arises. Hence, a solid oxide fuel cell in which a reforming catalyst is disposed in the fuel cell stack capable of reaching a high temperature so that the insufficiently reformed gas can be reformed at a suitable temperature before reaching the fuel-electrode layer, is being studied. However, when a reforming catalyst is disposed in a fuel cell stack, the flow path resistance of the fuel gas increases and the flow of the fuel gas is made non-uniform, depending on the loading amount of and the positions of the reforming catalyst, resulting in possible problems that the lack of the fuel gas amount fed to the fuel-electrode layer degrades the power generating performance, and the occurrence of an inhomogeneous temperature distribution in the power generating cell causes degradation and failure of the power generating cell.

Thus, the conventional solid oxide fuel cells employing the internal reforming method described above have various problems regarding cell performance and durability. In the present state of research and development, which has been progressed to solve these problems, their practical applications have not yet been available.

### SUMMARY OF THE INVENTION

It is a primary object of the present invention, achieved by taking such circumstances into consideration, to provide a solid oxide fuel cell which enables power generation with internal reforming stable and efficient in a long period.

It is also an object of the present invention to provide a solid oxide fuel cell which has a simple reforming mechanism and prevents the occurrence of an inhomogeneous temperature distribution in the cell generated by non-uniformity of reforming reaction and which enables power generation with internal reforming stable and efficient without breakage of the power generating cell and degrading of the cell performance. It is a further object of the present invention to provide a solid oxide fuel cell having an internal reforming mechanism which secures the gas flow path providing invariably good flow regions in the fuel cell stack without the influence of the loading amount of the reforming catalyst and provides an excellent reforming capability.

[A First Aspect of the Present Invention]

A solid oxide fuel cell according to a first aspect of the present invention has the following construction to achieve the objects mentioned above. A fuel-electrode layer and an air-electrode layer are disposed on both surfaces of a solid electrolyte layer. A fuel-electrode-side porous metal and an air-electrode-side porous metal are disposed on the outer surfaces of the fuel-electrode layer and the air-electrode layer, respectively. A separator is disposed on each of the outer surfaces of the fuel-electrode-side porous metal and the air-electrode-side porous metal. Then, the solid oxide fuel cell formed by closely adhering them all is characterized by that the pore interior of the fuel-electrode-side porous metal is partially or fully filled with a hydrocarbon reforming catalyst, by which reforming reaction is driven before a fuel gas reaches the fuel-electrode layer.

The fuel-electrode-side porous metal has a three-dimensional skeletal structure, and is preferably so constructed that pores formed by the skeleton have a near spindle shape of an average pore size of 80 to 800 μm.

Here, making the pores of the porous metal assume a spindle shape is to make the reforming catalyst particles with which the pore interior is filled less susceptible to dropping-off. Setting an average pore size of pores to be 80 to 800 μm is because pores of less than 80 μm interfere with the flow of the fuel gas, leading to not obtaining the desired power generating performance and because pores of larger than 800 μm make the flow of the fuel gas nonuniform, leading to not obtaining the desired power generating performance. An average pore size is preferably 200 to 600 μm.

In the solid oxide fuel cell, the hydrocarbon reforming catalyst is made to be particles which support on a ceramic carrier, an active metal component selected from the group consisting of nickel, palladium, ruthenium, platinum, rhodium, copper and combinations thereof, an average particle size of the particles being preferably 10 to 60% of the pore size of the fuel-electrode-side porous metal.

It is preferable that the fuel-electrode-side porous metal body has excellent current and thermal conductivities. A foamed metal, a mesh, a felt or the like composed of nickel, a nickel-based alloy, iron, an iron-based alloy or the like can be used as the porous metal body. When the porous metal body is constructed of Ni, etc., which has high catalytic activity, the reforming occurs also on the surface of the porous metal body, thereby obtaining higher reforming capability.

Here, making the size of the reforming catalyst particles 10 to 60% of the pore size of the porous metal is because the reforming catalyst particles of less than 10% drop easily off the pores and because those of larger than 60% are difficult to fill pores with and tend to make the flow of the fuel gas nonuniform. A particle size of the reforming catalyst particles is preferably 20 to 50% of the pore size of the porous metal.

The fuel-electrode-side porous metal may be constructed by laminating one or more sheets of a porous metal filled with the hydrocarbon reforming catalyst and one or more sheets of a porous metal filled with no catalyst and integrating them, or may be constructed by filling a porous metal plate having a three-dimensional skeletal structure with a hydrocarbon reforming catalyst and pressing it.

When the pore interior of the fuel-electrode-side porous metal is filled with the hydrocarbon reforming catalyst, loading amount of the reforming catalyst downstream of the fuel gas is preferably larger than that upstream thereof.

According to the first aspect of the present invention, reforming reaction can be performed by the hydrocarbon reforming catalyst before the fuel gas reaches the fuel-electrode layer without disturbing the flow of the fuel gas. The fuel-electrode-side porous metal functions simultaneously as a fuel-electrode-side gas channel, a current collector and a fuel reformer. Thus, the efficient and stable power generation with the internal reforming in a solid oxide fuel cell becomes possible.

[A Second Aspect of the Present Invention]

A solid oxide fuel cell according to a second aspect of the present invention has the following construction. The solid oxide fuel cell has at least one power generating cell in which a solid electrolyte layer is disposed between a fuel-electrode layer and an air-electrode layer, the fuel-electrode layer being composed of a material promoting reforming reaction of a fuel gas. Then, the solid oxide fuel cell is characterized by that a porous metal is disposed adjacent to the fuel-electrode layer, while a reforming catalyst composed of the same material as that of the fuel-electrode layer is loaded in the porous metal, and reforming reaction is caused by the reforming catalyst before the fuel gas reaches the fuel-electrode layer.

In the solid oxide fuel cell, the fuel-electrode current collector disposed adjacent to the fuel-electrode layer may be used as the porous metal.

The fuel-electrode layer may be formed of a composite material of Ni, Pd, Ru, Pt, Rh, Cu or combination thereof, and a ceramic, and one of (Ce_{0.8}·Sm_{0.2})O₂, (La_{0.8}·Sr_{0.2}) (Ga_{0.8}·Mg_{0.15}·Co_{0.05})O₃, and ZrO₂ doped with Y₂O₃ of 3 to 8 mol % may be used as the ceramic. Here, the average particle size of a particulate powder of Ni, Pd, Ru, Pt, Rh, Cu or combination thereof and the ceramic is preferably 10 μm or less.

It is preferable that the fuel-electrode-side porous metal body has excellent current and thermal conductivities. A foamed metal, a mesh, a felt or the like composed of nickel, a nickel-based alloy, iron, an iron-based alloy or the like can be used as the porous metal body. When the porous metal body is constructed of Ni, etc., which has high catalytic activity, the reforming occurs also on the surface of the porous metal body, thereby obtaining higher reforming capability.

According to the second aspect of the present invention, since the porous metal filled with the reforming catalyst composed of the same material as that of the fuel-electrode layer is disposed on the position adjacent to the fuel-electrode layer, and reforming reaction is driven by the reforming catalyst before the fuel gas reaches the fuel-electrode layer, the early degradation of the fuel-electrode layer due to reforming can be prevented. That is, gases (for example, hydrogen sulfide, and carbon monoxide of a high concentration) adversely affecting the fuel-electrode layer can be captured by the reforming catalyst loaded in the porous metal, and can be inhibited from flowing into the fuel-electrode layer. Thus, the early degradation and carbon deposition of the fuel-electrode layer by the gases can be prevented, and the power generating cell can be stably used in along period. Since the reforming catalyst composed of the same material as the fuel-electrode layer is employed, the occurrence of a chemical reaction between the reforming catalyst and the fuel-electrode layer can be prevented, which can prevent the decreasing of the catalytic action.

[A Third Aspect of the Present Invention]

A solid oxide fuel cell according to a third aspect of the present invention has the following construction. A fuel-electrode layer and an air-electrode layer are disposed on both surfaces of a solid electrolyte layer. A fuel-electrode current collector composed of a porous metal and an air-electrode current collector composed of a porous metal are disposed on the outer sides of the fuel-electrode layer and the air-electrode layer, respectively. A separator is disposed on each of the outer sides of the fuel-electrode current collector and the air-electrode current collector. A fuel gas and an oxidant gas are fed from the separators through the fuel-electrode current collector and the air-electrode current collector to the fuel-electrode layer and the air-electrode layer. Then, the solid oxide fuel cell is characterized by that the interior of the fuel-electrode current collector is filled with a hydrocarbon reforming catalyst, and loading amount of the reforming catalyst is larger downstream of the fuel gas than upstream thereof.

In the solid oxide fuel cell, for example, a structure is employable where the fuel gas and the oxidant gas are fed from the central parts of the separators through the fuel-electrode current collector and the air-electrode current collector to the fuel-electrode layer and the air-electrode layer. When this structure is employed, loading amount of the hydrocarbon reforming catalyst is preferably larger in the peripheral part of the fuel-electrode current collector than in the central part thereof.

Further, in the solid oxide fuel cell, it is preferable that the porous metal has a three-dimensional skeletal structure and the hydrocarbon reforming catalyst be loaded on the surface of the skeleton.

According to the third aspect of the present invention, since the interior of the fuel-electrode current collector is filled with the hydrocarbon reforming catalyst, and loading amount of the reforming catalyst is larger downstream of the fuel gas than upstream thereof, the temperature distribution in the power generating cell can be uniformed, which levels the electric current density distribution, and which prevents the generation of the thermal stress due to the inhomogeneous temperature distribution, thereby preventing degradation and breakage of the power generating cell.

Since the porous metal has the three-dimensional skeletal structure and the hydrocarbon reforming catalyst is loaded on the surface of the skeleton, an invariably good gas flow path is secured in the fuel-electrode current collector and an always sufficient reformed gas is fed to the fuel-electrode layer, thereby leading to the efficient and stable power generation. Besides, the reforming mechanism is simplified.

[A Fourth Aspect of the Present Invention]

A solid oxide fuel cell according to a fourth aspect of the present invention has the following construction. A fuel-electrode layer and an air-electrode layer are disposed on both surfaces of a solid electrolyte layer. A fuel-electrode current collector composed of a porous metal and an air-electrode current collector composed of a porous metal are disposed on the outer sides of the fuel-electrode layer and the air-electrode layer, respectively. A separator is disposed on each of the outer sides of these current collectors. Reactant gases are fed from the separators through the current collectors to the fuel-electrode layer and the air-electrode layer, respectively. Then, the solid oxide fuel cell is characterized by that a hydrocarbon reforming catalyst is disposed between the separator and the fuel-electrode current collector.

In the solid oxide fuel cell, it is preferable that the hydrocarbon reforming catalyst be loaded on the porous metal body excellent in electric and thermal conductivities, which be provided with a through-hole penetrating from a reactant gas discharging part of the separator to the fuel-electrode current collector side. In this case, the fuel-electrode current collector functions as a flow path for the fuel gas, and the porous metal body functions as a carrier for the hydrocarbon reforming catalyst. A porous metal, a mesh, a felt or the like composed of nickel, a nickel-based alloy, iron, an iron-based alloy or the like can be used as the porous metal body. When the porous metal body is constructed of Ni, etc., which has a high catalytic activity, the reforming occurs also on the surface of the porous metal body, thereby obtaining enhanced reforming capability.

In the solid oxide fuel cell, the fuel gas introduced through the separator into the fuel-electrode current collector contacts with the adjacent reforming catalyst layer in the process of the fuel gas diffusing and transferring in the current collector, and reforming reaction of the fuel gas occurs at the contacting portions.

According to the fourth aspect of the present invention, since, with the reforming catalyst layer disposed between the separator and the fuel-electrode current collector, the reforming catalyst obstructing the fuel gas flow through the fuel gas flow path is not present, the gas flow path having invariably good flowing in the fuel cell stack can be secured without being influenced by loading amount of the hydrocarbon reforming catalyst, resulting in the efficient and stable power generation with the internal reforming.

Besides, since the hydrocarbon reforming catalyst is disposed in a place, where the temperature is highest in the fuel cell stack, between the separator and the fuel-electrode current collector, even a low-temperature operating fuel cell invariably secures an optimal reforming temperature, and can provide an excellent reforming capability. As a result, with reforming reaction activated, a hydrogen-rich fuel gas is obtained in the reforming catalyst layer while the problem of carbon deposition by an unreformed gas can be avoided.

Further, temperature differences occur by endothermal reaction in the reforming catalyst layer, but providing the gas flow path between the cell and the reforming catalyst layer avoids the failure of the cell due to the temperature differences in the reforming catalyst layer.

### BRIEF DESCRIPTION OF THE DRAWINGS

FIG. 1 is an exploded perspective view showing a fuel cell stack of a solid oxide fuel cell in a first embodiment according to the present invention;

FIG. 2 is an essential part sectional view of the fuel cell stack in FIG. 1;

FIG. 3 is an essential part sectional view of a fuel cell stack other than that in FIG. 2;

FIG. 4 is an essential part sectional view of a fuel cell stack other than that in FIG. 3;

FIG. 5 is an exploded perspective view showing a fuel cell stack of a solid oxide fuel cell in a second embodiment according to the present invention;

FIG. 6 is a schematic view showing a sectional structure of the fuel-electrode current collector of the fuel cell stack in FIG. 5;

FIG. 7 is an exploded perspective view showing a fuel cell stack of a solid oxide fuel cell in a third embodiment according to the present invention;

FIG. 8 is a sectional view showing an internal structure of a unit cell of the solid oxide fuel cell in FIG. 7;

FIG. 9A, FIG. 9B and FIG. 9C are diagrams illustrating temperature distributions in a power generating cell;

FIG. 10 is an exploded perspective view showing a solid oxide fuel cell (a fuel cell module) in a fourth embodiment according to the present invention;

FIG. 11 is a sectional view showing an internal structure of a unit cell; and

FIG. 12 is a sectional view of a porous metal body supporting a hydrocarbon reforming catalyst.

### DETAILED DESCRIPTION OF THE PREFERRED EMBODIMENTS

### A First Embodiment

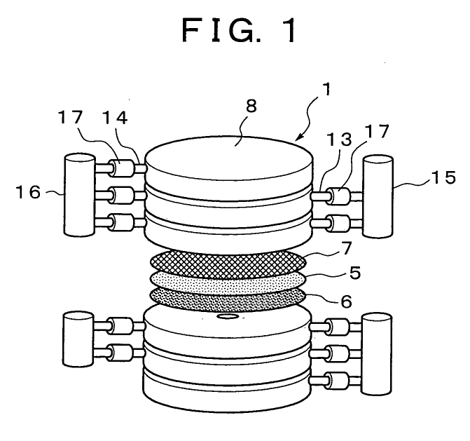

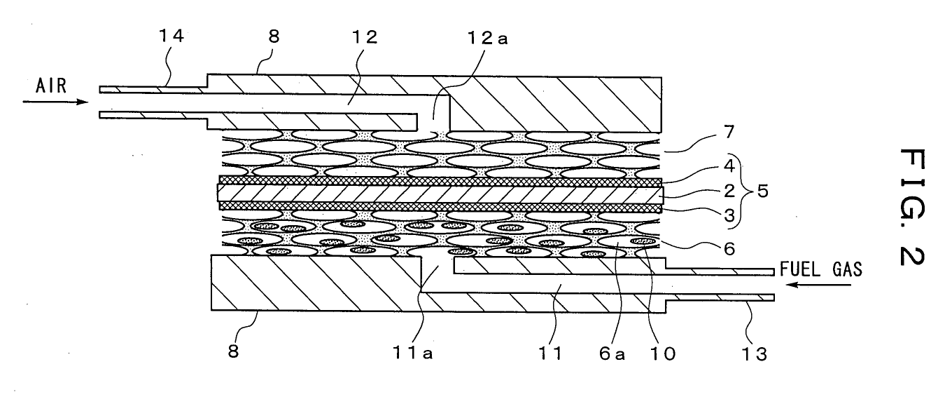

A first embodiment of a solid oxide fuel cell of a flat-plate stacking type according to the present invention will be illustrated. FIG. 1 is an exploded perspective view showing a fuel cell stack construction. FIG. 2 to FIG. 4 are sectional views showing essential parts of fuel cell stacks different from each other.

As shown in FIG. 1 to FIG. 4, a fuel cell stack 1 (hereinafter, referred to simply as stack 1) has a structure in which a power generating cell 5 disposing a fuel-electrode layer 3 and a air-electrode layer 4 on both surfaces of a solid electrolyte layer 2, an fuel-electrode-side porous metal 6, an air-electrode-side porous metal 7, and separators 8 on the outer sides of the porous metals 6 and 7, respectively, are stacked in the order.

The solid electrolyte layer 2 is composed of a stabilized zirconia doped with yttria (YSZ), etc.; the fuel-electrode layer 3 a metal of Ni, etc. or a cermet of Ni-YSZ, etc.; the air-electrode layer 4 LaMnO₃, LaCoO₃, etc.; the fuel-electrode-side porous metal 6 a spongy porous sintered metal plate made of Ni, Fe-based alloy, etc.; the air-electrode-side porous metal 7 a spongy porous sintered metal plate made of Ag, etc.; and the separators 8 a stainless steal, etc.

The separators 8 connect electrically between the power generating cells 5, and have a function of feeding gases to the power generating cells 5. Each separator 8 has a fuel flow channel 11 into which a fuel gas is introduced from the outer periphery of the separator 8 and out of which the gas is discharged at the nearly central part of the surface of the separator 8 facing the fuel-electrode-side porous metal 6; and an oxidant flow channel 12 into which an oxidant gas is introduced from the outer periphery of the separator 8 and out of which the gas is discharged at the nearly central part of the surface of the separator 8 facing the air-electrode-side porous metal 7.

On the side of the stack 1, a fuel distributor (a fuel manifold) 15 to feed the fuel gas through connecting pipes 13 to the respective fuel flow channels 11 of the separators 8, and an oxidant distributor (an oxidant manifold) 16 to feed the oxidant gas (air) through connecting pipes 14 to the respective oxidant flow channels 12 of the separators 8, are provided extending in the stacking direction of the power generating cells 5. Herein, reference numeral 17 denotes couplings made of a ceramic to secure the electric insulation between the cells.

Here, the porous metals 6 and 7 can be fabricated through the following processes. The order of the processes is a slurry preparing one→a molding one→a foaming one->a drying one→a degreasing one→a sintering one.

First, in the slurry preparing process, a foam slurry is prepared by mixing a metal powder, an organic solvent (n-hexane, etc.), a surfactant (sodium dodecylbenzenesulfonate, etc.), a water-soluble resin binder (hydroxypropyl methylcellulose, etc.), a plasticizer (glycerin, etc.), and water. In the molding process, a green sheet is obtained by molding the resulting slurry on a carrier sheet into a thin film by the doctor blade method. Next, in a foaming process, the green sheet is foamed into a sponge-form under a high temperature and a high humidity utilizing the vapor pressure of the volatile organic solvent and the foamability of the surfactant, and then, through the drying, degreasing and sintering processes, a porous metal plate is obtained. The thickness of the porous metal plate is about 1.6 mm.

In the foaming process, bubbles generated in the green sheet grow nearly spherically under isostatic pressure. As the bubbles diffuse from the inside and approach the interface with the atmosphere, the bubbles grow into the thin part of the slurry between the bubbles and the atmosphere, and soon break, the gas in the bubbles diffusing from small holes made at the break into the atmosphere. The porous metal plate having continuous pores having openings on the surface is thus obtained. In this state, the pores assume near spherical shape of about 300 to 500 μm in diameter.

The porous metal plate thus fabricated which have a three-dimensional structure is cut into a disc.

A stack unit is constructed of the power generating cell 5, the porous metals 6 and 7 cut into a disc, and the separators 8 on the outsides of the porous metals 6 and 7, and a plurality of the stack units are conventionally stacked into the stack 1. In this stacking time, the porous metal plates 6 and 7 are compressed by the stacking pressure, and the nearly spherical pores 6a are deformed into a spindle-shape of 80 to 800 μm in the average pore size as shown in FIG. 2. The uniform gas flow is secured within the range of the pore sizes.

According to the present invention, an internal reforming mechanism is constructed by partially or fully filling the interior of pores 6a of the fuel-electrode-side porous metal 6 with a hydro carbon reforming catalyst 10 prior to the stacking process. A composite material supporting a nickel catalyst on a ceramic carrier is commonly used as the hydrocarbon reforming catalyst 10. Instead of nickel, however, palladium, ruthenium, platinum, rhodium, copper and the like may be used.

According to the embodiment, the composite material of the ceramic and nickel is pulverized and made into a predetermined particle size through a mesh and into reforming catalyst particles 10. The reforming catalyst particles 10 are sprinkled onto the fuel-electrode-side porous metal 6, and then penetrate through nearly spherical openings in the porous metal surface, and are dispersed and loaded uniformly in the pores 6a. Nickel particles of about 50 nm in the particle size are loaded in the reforming catalyst particles 10.

In the embodiment, taking into consideration the ease of the fuel gas flow (uniformity) in the porous metal in addition to the ease of filling the pores 6a and prevention of dropping off the pores 6a, the diameter of the reforming catalyst particles 10 is set to be at 10 to 60% of the pore size of the fuel-electrode-side porous metal 6.

Through this method, the pores in the fuel-electrode-side porous metal 6 is filled with the reforming catalyst particles 10, and then the power generating cell 5, the porous metals 6 and 7, and the outside separators 8 are closely adhered under a prescribed pressure into the stack unit as described above.

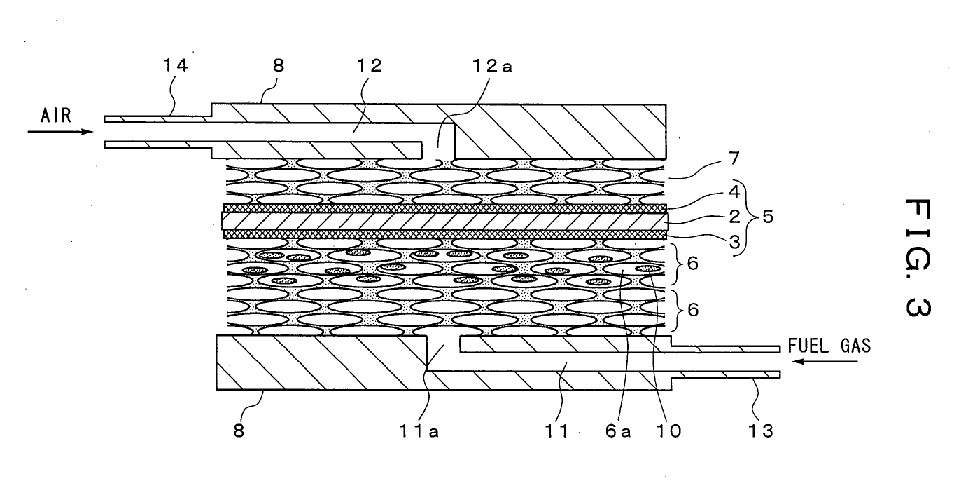

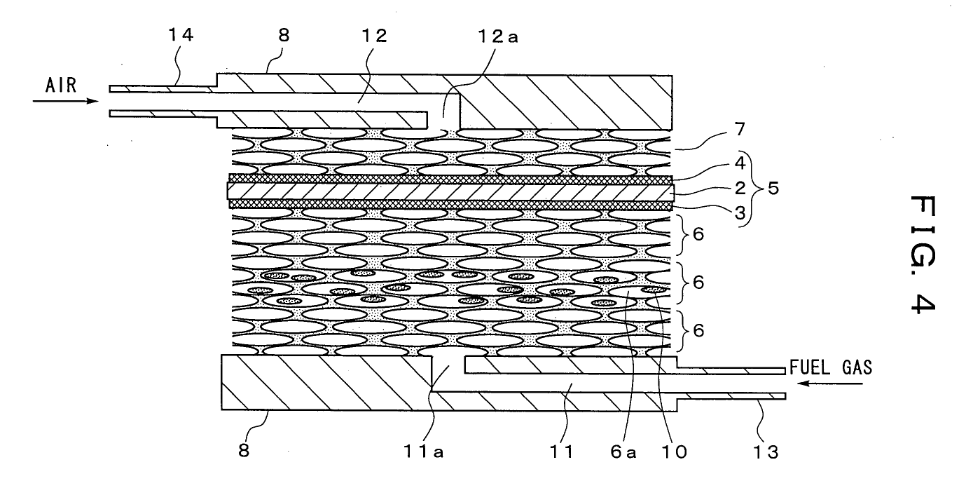

Now, the fuel-electrode-side porous metal 6 may have structures shown in FIG. 3 and FIG. 4 besides the structure shown in FIG. 2.

The structure shown in FIG. 3 is an example in which a porous metal plate 6 not filled with the reforming catalyst is laminated and closely adhered to the underside (separator side) of a porous metal 6 filled with the reforming catalyst particles 10; and the structure shown in FIG. 4 is an example in which porous metal plates 6 not filled with the reforming catalyst are laminated and closely adhered on and under a porous metal 6 filled with the reforming catalyst particles 10.

In this way, disposing the porous metal plate 6 not filled with the reforming catalyst makes the gas flow in the porous metal uniform, thereby allowing the efficient power generation.

In the stacks 1 constructed by stacking a plurality of the stack units having the structures described above, the oxidant gas (air) fed from outside is introduced through the oxidant distributor 16 and a plurality of the connecting pipes 14 into the oxidant flow channels 12 of the respective separators 8, and discharged from oxidant gas discharge openings 12a in the ends of the flow channels and fed to the air-electrode-side porous metals 7 facing the separators, and reaches the air-electrode layers 4 of the power generating cells 5 through the air-electrode-side porous metals 7.

On the other hand, the fuel gas (a mixture of CH₄ and steam) fed from outside is introduced through the fuel distributor 15 and a plurality of the connecting pipes 13 into the fuel flow channels 11 of the respective separators 8, and discharged from fuel gas discharge openings 11a in the ends of the flow channels and fed to the fuel-electrode-side porous metals 6 facing the separators.

Here, the fuel gas contacts with the reforming catalyst loaded in the fuel-electrode-side porous metal 6 and starts reforming reaction. Reforming reaction, which is as described before and whose explanation is omitted, reforms the fuel gas into hydrogen and carbon monoxide. The reformed gas reaches the fuel-electrode layers 3 of the power generating cells 5 through the fuel-electrode-side porous metals 6, and is again subjected to reforming on the fuel-electrodes.

Reforming catalyst loaded in the fuel-electrode-side porous metal 6 has a reforming capability equal to or greater than the fuel-electrode, since nickel particles contained in the catalyst have an extremely small size of about 50 μm, having an extremely large total specific surface area.

A foamed metal composed of, for example, nickel, a nickel-based alloy, iron and an iron-based alloy can be used as the porous metal body 6. If the porous metal body 6 is composed of Ni, etc. having a high catalytic activity as in the case of the foamed metal, reforming reaction is performed also on the surface of these porous metal bodies 6, thereby obtaining higher reforming capability.

The conventional solid oxide fuel cell which employs the internal reforming method, as described before, has problems influencing the performance and durability of the cell, such as fluctuations and drops of generated voltage and debonding between the electrode layer and the solid electrolyte layer. It is estimated that the steam generated in the electrode reaction and reforming reaction in the power generation process causes repeating oxidation and reduction of the metal such as Ni contained in the fuel-electrode layer, and the repeating thermal shrinkage caused by that brings about the electrode debonding leading to degradation of the cell performance and durability.

From this point of view, the present invention intends to suppress oxidation of the electrode and improve the cell performance and durability by generating hydrogen by starting in advance reforming reaction in the fuel-electrode current collector before the occurrence of the electrode and reforming reactions in the fuel-electrode layer.

Besides, the present invention employs the structure in which the reforming catalyst 10 is loaded in the pores 6a in the fuel-electrode-side porous metal 6 without employing a special reforming mechanism for the internal reforming, enabling an efficient and stable internal reforming power generation.

### A Second Embodiment

Now, a second embodiment of a solid oxide fuel cell according to the present invention will be illustrated. In the embodiment, the same reference numerals are given for the same components as in the first embodiment described above, and their explanation is simplified.

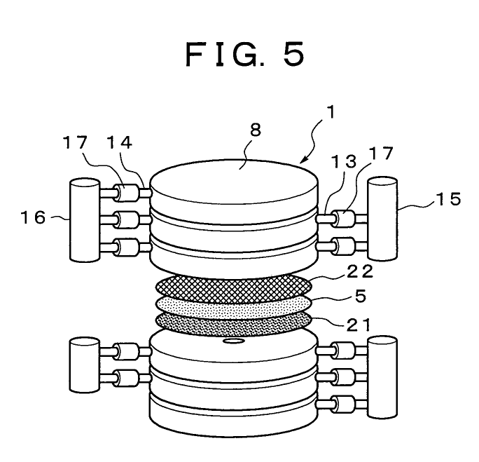

A fuel cell stack 1 of the embodiment, as shown in FIG. 5, has a structure in which a fuel-electrode current collector 21 and an air-electrode current collector 22 are disposed on both sides of a power generating cell 5, and separators 8 are disposed on the outer sides of the current collectors 21 and 22.

A power generating cell 5 has, as shown in the first embodiment described above, a lamination structure in which a solid electrolyte layer 2 is interposed between an air-electrode layer 4 and a fuel-electrode layer 3. The solid electrolyte layer 2 is composed of a stabilized zirconia doped with yttrium (YSZ), etc. and the air-electrode layer 4 is composed of LaMnO₃, LaCoO₃, etc.

The fuel-electrode layer 3 is composed of cermet of Ni, Pd, Ru, Rh, Pt or Cu, and a ceramic. As the ceramic, one of (Ce_{0.8}·Sm_{0.2})O₂:“SDC” (La_{0.8}·Sr_{0.2}) (Ga_{0.8}·Mg_{0.15}·Co_{0.05})O₃, and ZrO₂ doped with Y₂O₃ of 3 to 8 mol %:“YSZ” can be used. A composite material of the metal such as Ni and the ceramic functions as a reforming catalyst to promote reforming reaction of a fuel gas, the SDC and YSZ having a function of suppressing growth of particles of Ni, etc. The fuel-electrode current collector 21 is disposed at a position adjacent to the fuel-electrode layer 3, and the air-electrode current collector 22 is disposed at a position adjacent to the air-electrode layer 4.

The fuel-electrode current collector 21 and the air-electrode current collector 22 are both composed of porous metals in a sponge-form. An Ag-based alloy, etc. is used for the air-electrode current collector 22, and Ni, Fe-based alloy, etc. is used for the fuel-electrode current collector 21. The fuel-electrode current collector 21, as described later, supports a reforming catalyst composed of the same material as that of the fuel-electrode layer 3, and reforming reaction is designed to occur by the reforming catalyst before the fuel gas reaches the fuel-electrode layer 3.

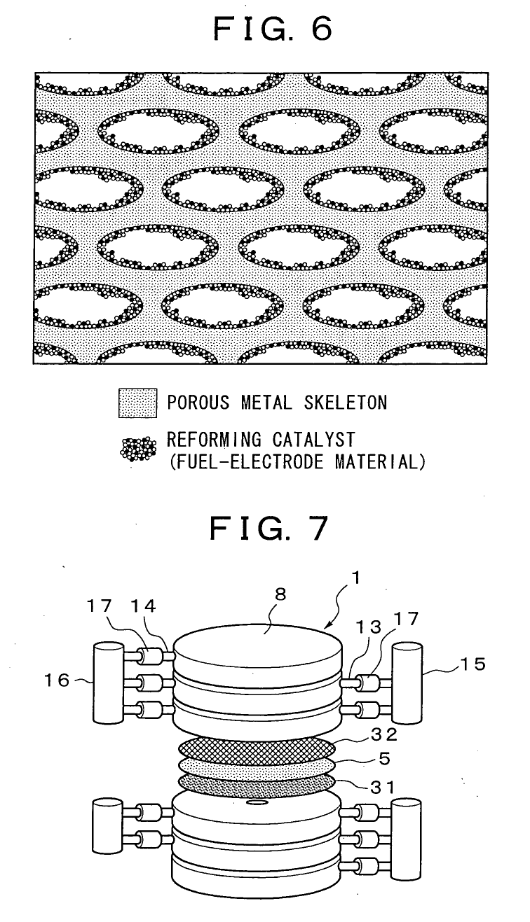

The fuel-electrode current collector 21 has a structure in which the reforming catalyst composed of the same material as that of the fuel-electrode layer 3 is, as shown in FIG. 6, loaded on the skeletal surface of a porous metal having a three-dimensional skeletal structure fabricated by the same method as in the porous metals 6 and 7 of the first embodiment described above. The reforming catalyst is a mixture of a particulate powder of 10 μm or less in the average particle size of Ni, Pd, Ru, Pt, Rh, Cu or combination thereof, and a particulate powder of a ceramic of 10 μm or less in the average particle size, and has the entirely same material composition as the fuel-electrode layer 3. For example, when the fuel-electrode layer 3 is composed of a cermet of Ni-SDC, a mixture of a particulate powder of Ni and a particulate powder of SDC is used as a reforming catalyst. For example, a particulate powder is doped with an organic solvent and a diluent to form a slurry. A porous metal is immersed in the slurry, and then dried and baked, whereby the reforming catalyst is loaded on the skeletal surface of the porous metal.

In the solid oxide fuel cell having the above structure, the air introduced from outside through an oxidant manifold 16 into separators 8 is discharged from the nearly central part of each separator 8 toward the air-electrode current collector 22, and then reaches the air-electrode layer 4 of each power generating cell 5 while diffusing in the direction to the periphery.

On the other hand, the fuel gas (a mixture of CH₄ and steam) introduced from outside through a fuel manifold 15 into separators 8 is discharged from the nearly central part of each separator 8 toward the fuel-electrode current collector 21, and then reaches the fuel-electrode layer 3 of each power generating cell 5 diffusing in the direction to the periphery. The fuel gas, in the process of passing through each fuel-electrode current collector 21, contacts with the reforming catalyst loaded on the skeletal surface of the porous metal, starts reforming reaction, and is converted into hydrogen and carbon monoxide during the time until reaching the interface between the fuel-electrode layer 3 and the solid electrolyte layer 2.

Consequently, oxygen is fed to the vicinity of the interface between the air-electrode layer 4 and the solid electrolyte layer 2 while hydrogen is fed to the vicinity of the interface between the fuel-electrode layer 3 and the solid electrolyte layer 2, whereby the power generating reactions occur by the respective gases on the respective electrodes of each power generating cell 5.

According to the second embodiment as above, since the reforming catalyst composed of the same material as that of the fuel-electrode layer 3 is loaded in the fuel-electrode current collector (a porous metal) 21 adjacent to the fuel-electrode layer 3, and reforming reaction is driven by the reforming catalyst before the fuel gas reaches the fuel-electrode layer 3, the early degradation of the fuel-electrode layer 3 due to reforming can be prevented. That is, gases (for example, hydrogen sulfide, and carbon monoxide of a high concentration) adversely affecting the fuel-electrode layer 3 can be captured by the fuel-electrode current collector 21, and can be inhibited from flowing into the fuel-electrode layer 3. Thus, the early degradation and carbon deposition of the fuel-electrode layer 3 by the gases can be prevented, and the power generating cell 5 can be stably used in a long period. Since the reforming catalyst composed of the same material as that of the fuel-electrode layer 3 is employed, the occurrence of a chemical reaction between the reforming catalyst and the fuel-electrode layer 3 can be prevented, which can prevent the drop of the catalytic action.

Further, in the embodiment, since the reforming catalyst is loaded in the fuel-electrode current collector 21, the electric conductivity of the fuel-electrode current collector 21 can be improved. Besides, since one of SDC, YSZ, and (La_{0.8}·Sr_{0.2}) (Ga_{0.8}·Mg_{0.15}·Co_{0.05}) O₃ is used as a ceramic material composing the reforming catalyst, the decrease in the specific surface area due to size enlargement of the particles such as Ni in the high-temperature operation can be prevented. Since Ni, Pd, Ru, Pt, Rh or Cu powder and the ceramic powder, which compose the reforming catalyst together, have an average particle size of 10 μm or less, reforming reaction can be efficiently performed.

In the embodiment, the reforming catalyst is loaded on the fuel-electrode current collector 21 composed of a porous metal, but the present invention is not limited to this. A porous metal may be disposed, for example, in the fuel flow channel in the separator 8, a region from the fuel flow channel to the fuel-electrode layer 3 or others, and the reforming catalyst may be loaded in the porous metal.

A foamed metal composed of, for example, nickel, a nickel-based alloy, iron and an iron-based alloy can be used as the porous metal body 21. If the porous metal body 21 is composed of Ni, etc. having a high catalytic activity as in the case of the foamed metal, reforming reaction is performed also on the surface of these porous metal bodies 21, thereby obtaining higher reforming capability.

In the embodiment, a foamed body is employed as the porous metal, but a mesh and a felt may be employed.

### A Third Embodiment

A third embodiment of a solid oxide fuel cell according to the present invention will be now illustrated. In the embodiment, the same reference numerals are given for the same components as in the embodiments described above to simplify the description thereof.

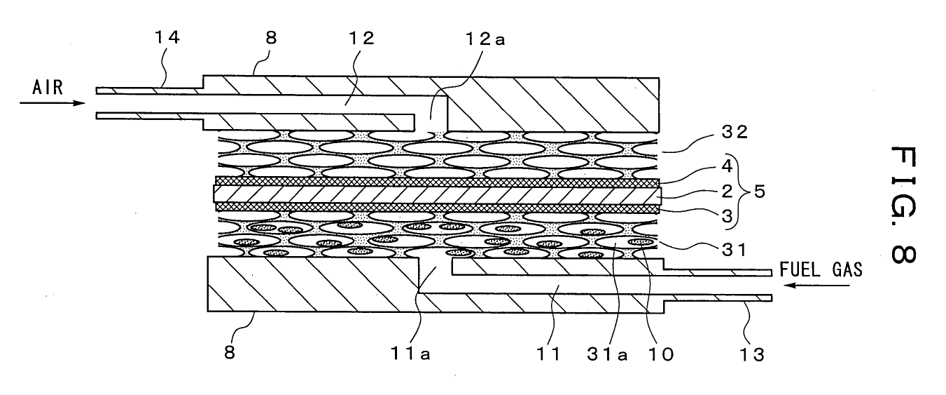

In the third embodiment, as shown in FIG. 7 and FIG. 8 as in the second embodiment described above, a stack unit is constructed of a power generating cell 5 in which a fuel-electrode layer 3 and an air-electrode layer 4 are disposed on both surfaces of a solid electrolyte layer 2, a fuel-electrode current collector 31 disposed on the outer side of the fuel-electrode layer 3, an air-electrode current collector 32 disposed on the outer side of the air-electrode layer 4, and separators 8 disposed on the outer sides of the current collectors 31 and 32, respectively, a plurality of the stack units being stacked into a cylindrical fuel cell stack 1.

The solid electrolyte layer 2 is composed of a stabilized zirconia doped with yttria (YSZ), etc.; the fuel-electrode layer 3 a metal of Ni, etc. or a cermet of Ni-YSZ, etc.; the air-electrode layer 4 LaMnO₃, LaCoO₃, etc.; the fuel-electrode current collector 31 a spongy porous sintered metal plate (a foamed metal plate) made of Ni, etc.; the air-electrode current collector 32 a spongy porous sintered metal plate (a foamed metal plate) made of Ag, etc.; and the separators 8 a stainless steel, etc.

In the third embodiment, a foamed metal plate having a three-dimensional structure constituting the fuel-electrode current collector 31 is fabricated by the same method as in the porous metals 6 and 7 in the first embodiment described before, and then the foamed metal plate is partially or fully filled with a hydrocarbon reforming catalyst 10 to construct an internal reforming mechanism as shown in FIG. 8. A composite material supporting a Ni catalyst on an alumina powder is usually employed as the hydrocarbon reforming catalyst 10. Pd, Ru, Pt, Rh or Cu can be employed instead of Ni. The alumina carrier is preferably a γ-alumina powder with a large surface area.

The alumina powder supporting Ni etc. is sieved by meshes into a predetermined size suitable for use. The alumina powder is adhered dispersedly to the interior (that is, skeletal surface) of the pores 31a of the foamed metal.

Now, in the internal reforming fuel cell, an inhomogeneous temperature distribution in the power generating cell due to the endothermic reaction caused by reforming reaction occurs as mentioned before, and problems of breakage of the power generating cell and decrease in the cell performance due to the inhomogeneous temperature distribution have arisen.

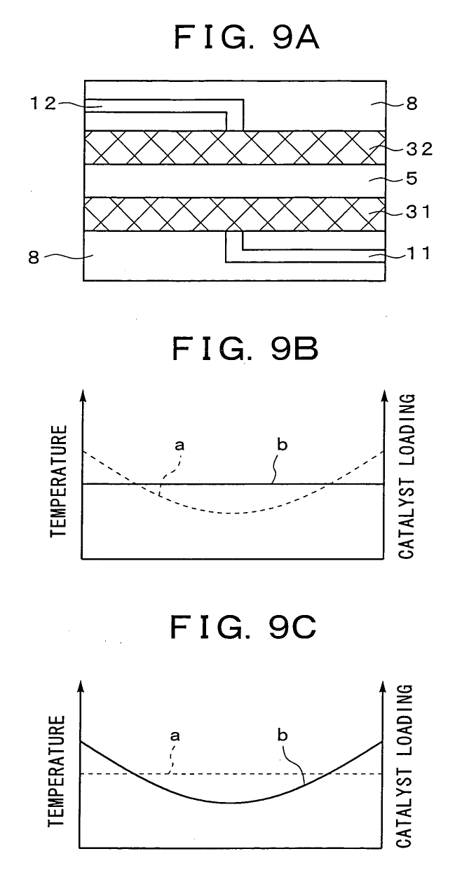

FIG. 9A, FIG. 9B and FIG. 9C are figures for illustrating the temperature distribution in the power generating cell 5. The symbol ‘a’ in the figures denotes an amount of the hydrocarbon reforming catalyst, and ‘b’ denotes a temperature distribution; and the abscissas in FIG. 9B and FIG. 9C correspond to the horizontal position in FIG. 9A.

In the case where the hydrocarbon reforming catalyst 10 is uniformly dispersed in the entire interior of the fuel-electrode current collector 31, reforming reaction of a fuel gas tends to be active in the early reaction period and have a much endothermic quantity, and the endothermic quantity tends to exponentially decrease with the progressing reforming reaction. In the case where a fuel gas is fed from the central part of the separator 8 as shown in FIG. 9A, therefore, the endothermic quantity at the central part of the fuel-electrode current collector 31, which is on the inlet side of the fuel gas, is large, and decreases toward the outlet of the fuel gas. As a result, the temperature of the central part of the power generating cell is, as shown in FIG. 9C, lower than that of the peripheral part.

Therefore, in the embodiment, loading amount of the hydrocarbon reforming catalyst 10 is increased progressively from the central part (upstream) of the fuel-electrode current collector 31 to the periphery part (downstream), as shown in FIG. 9B.

That is, steam reforming reaction in the fuel-electrode current collector 31 is made to uniformly occur by suppressing reforming reaction by decreasing loading amount of the hydrocarbon reforming catalyst 10 in the central part of the fuel-electrode current collector 31 because steam reforming reaction responsible for the temperature decrease easily occurs in the central part of the fuel-electrode current collector 31, and by activating reforming reaction by increasing loading amount of the hydrocarbon reforming catalyst 10 progressively to the periphery of the fuel-electrode current collector 31. Hence, temperature deviation in the power generating cell 5 can be suppressed to uniform the temperature distribution and level the electric current density distribution therein.

In the stack 1 where a plurality of the stack units having the structure described above are stacked, the oxidant gas (air) fed from the outside is introduced through an oxidant manifold 16 from a plurality of connecting pipes 14 to oxidant flow channels 12 of the respective separators 8, discharged out of oxidant gas discharge openings 12a at the ends of the channels and fed to the air-electrode current collectors 32 facing them, and reaches the air-electrode layer 4 of the power generating cell 5 while diffusing in the current collectors 32.

On the other hand, the fuel gas (a mixture of CH₄ and steam) fed from outside is introduced through a fuel manifold 15 from a plurality of connecting pipes 13 to fuel gas flow channels 11 of the respective separators 8, discharged out of fuel gas discharge openings 11a at the ends of the channels and fed to the fuel-electrode current collectors 31 facing them.

Now, the fuel gas contacts with a hydrocarbon reforming catalyst 10 loaded in the pores 31a in the fuel-electrode current collector 31 in the process of diffusing and transferring in the fuel-electrode current collector 31, which starts reforming reaction. In the embodiment, as shown in FIG. 9B, since loading amount of the hydrocarbon reforming catalyst 10 is small at the inlet part of the fuel gas, reforming reaction is suppressed, and the endothermic quantity decreases at the inlet part of the fuel gas. By contrast, since loading amount of the hydrocarbon reforming catalyst 10 increases progressively from the central part of the fuel-electrode current collector 31 to the periphery part thereof, the unreacted fuel gas having undergone no reforming reaction yet is activated in the process of diffusing and transferring to the peripheral part, and the endothermic quantity increases progressively.

As a result, as shown in FIG. 9B, the temperature distribution in the power generating cell is uniformed, and the electric current density distribution can be leveled. Besides, the thermal stress generated in the cell due to the inhomogeneous temperature distribution is prevented, and degradation and breakage of the power generating cell 5 is prevented.

Reforming reaction in the fuel-electrode current collector 31 is as mentioned before, and its explanation is omitted here; the fuel gas is reformed into hydrogen and carbon monoxide through reforming reaction. The reformed gas reaches the fuel-electrode layer 3 of the power generating cell 5 from the fuel-electrode current collector 31, and reforming reaction is again performed in the fuel-electrode.

Thus, the present invention has the simplified internal reforming mechanism by employing the structure in which the hydrocarbon reforming catalyst 10 is loaded in the pores 31a in the fuel-electrode current collector 31, and enables the efficient and stable power generation with the internal reforming.

### A Fourth Embodiment

Now, a fourth embodiment of a solid oxide fuel cell according to the present invention will be illustrated. In the embodiment, the same reference numerals are given for the same components as in the embodiments described above, and their explanation is simplified.

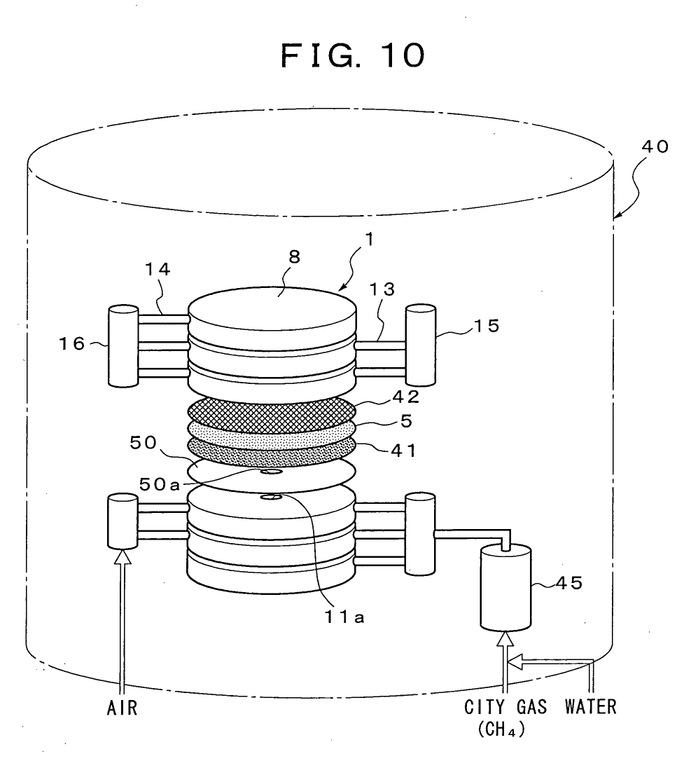

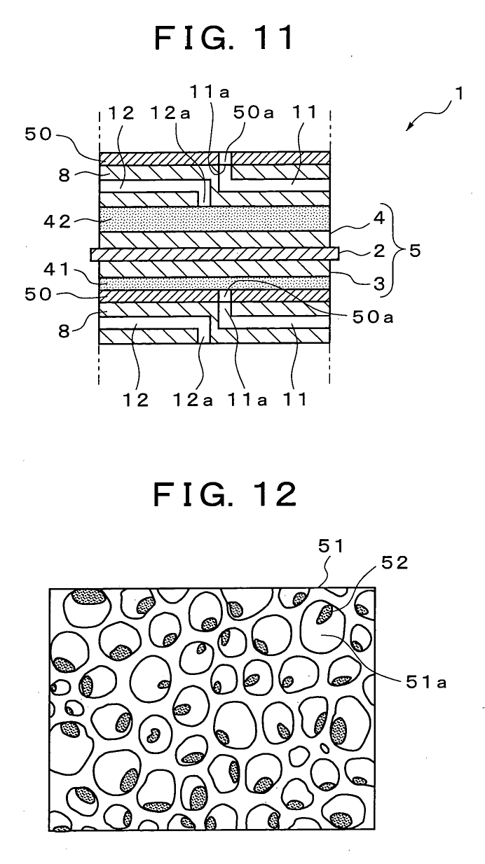

In the fourth embodiment, as shown in FIG. 10 and FIG. 11 as in the third embodiment described above, a stack unit is constructed of a power generating cell 5 in which a fuel-electrode layer 3 and an air-electrode layer 4 are disposed on both surfaces of a solid electrolyte layer 2, a fuel-electrode current collector 41 disposed on the outer side of the fuel-electrode layer 3, an air-electrode current collector 42 disposed on the outer side of the air-electrode layer 4, and separators 8 disposed outside the current collectors 41 and 42, respectively, a plurality of the stack units being stacked into a cylindrical fuel cell stack 1.

The solid electrolyte layer 2 is composed of a stabilized zirconia doped with yttria (YSZ), etc.; the fuel-electrode layer 3 a metal of Ni, etc. or a cermet of Ni-YSZ, etc.; the air-electrode layer 4 LaMnO₃, LaCoO₃, etc.; the fuel-electrode current collector 41 a porous sintered metal plate (a foamed metal plate) in a sponge-form of Ni, Fe-based alloy, etc.; the air-electrode current collector 42 a porous sintered metal plate (a foamed metal plate) in a sponge-form of Ag, etc.; and the separators 8 a stainless steel, etc.

On the sides of the fuel cell stack 1, a fuel manifold 15 through which the fuel gas is introduced and distributed and an oxidant manifold 16 through which the air is introduced and distributed, are disposed in the stacking direction of the power generating cells 5. A reformer 45 internally having the hydrocarbon reforming catalyst is connected with the upstream of the fuel manifold 15. The fuel manifold 15 is connected through connecting pipes 13 to fuel flow channels 11 of the respective separators 8, and the oxidant manifold 16 is connected through connecting pipes 14 to oxidant flow channels 12 of the respective separators 8.

The fuel cell stack 1, the manifolds 15 and 16, the reformer 45, etc. are collectively encased in an thermally insulating cylindrical can to construct a fuel cell module 40, as shown in FIG. 10.

In the fourth embodiment, a reforming catalyst layer 50 is disposed between the separator 8 and the fuel-electrode current collector 41, the reforming catalyst layer 50 constituting the reforming mechanism in the fuel cell stack 1.

The reforming catalyst layer 50 is, as shown in FIG. 12, a thin plate member supporting hydrocarbon reforming catalyst particles 52 in a circular porous metal body 51. The thin plate member is interposed between the separator 8 and the fuel-electrode current collector 41 so as to cover the upper surface of the separator 8, and stacked together with the power generating cell 5, thus making a state that both surfaces thereof are closely adhered to the separator 8 and the fuel-electrode current collector 41.

The reforming catalyst layer 50 is, as shown in FIG. 10 and FIG. 11, equipped with a through-hole 50a in the nearly central part thereof which communicates with the fuel gas discharge opening 11a of the separator 8 facing it and opens to the surface of the fuel-electrode current collector 41, the fuel gas introduced into the fuel flow channel 11 of the separator 8 being supplied from the discharge opening 11a through the through-hole 50a to the fuel-electrode current collector 41.

A foamed metal composed of, for example, nickel, a nickel-based alloy, iron, and an iron-based alloy can be used as the porous metal body 51. As shown in FIG. 12, the hydrocarbon reforming catalyst particles 52 are uniformly dispersedly adhered in a number of pores 51a of the porous metal body 51.

A composite material supporting a Ni catalyst on a ceramic carrier can be used as the hydrocarbon reforming catalyst particles 52. Pd, Ru, Pt, Rh, Cu or combination thereof can be used instead of Ni.

A mesh, a felt, or the like instead of the foamed metal may be used as the porous metal body 51, in any of which the hydrocarbon reforming catalyst particles 52 are uniformly dispersedly loaded in the pores or on the surface of the fibrous metal.

If these porous metal bodies are composed of Ni, etc. having a high catalytic activity as in the case of the foamed metal, reforming reaction is performed also on the surface of these porous metal bodies 51, and the reforming catalyst layer 50 obtains a high reforming capability. Additionally, these porous metal bodies 51 composed of Ni etc. have an excellent electric conductivity, and serve as an excellent electric current collecting function together with the fuel-electrode current collector 41, and have a merit of excellent workability.

In the fuel cell stack 1 having the internal reforming mechanism having the above structure, the air fed from outside is distributed through an oxidant manifold 16 and a plurality of the connecting pipes 14, and introduced into the oxidant flow channels 12 of the respective separators 8, and discharged from oxidant gas discharge openings 12a in the ends of the flow channels and fed to the air-electrode current collectors 42 facing the separators, and reaches the air-electrode layers 4 of the power generating cell 5 while diffusing from the center to the periphery in the air-electrode current collector 42.

On the other hand, after the fuel gas (a mixture of CH₄ and steam) fed from outside is reformed by the reformer 45 in the fuel cell module 40, the reformed gas is distributed through the fuel manifold 15 and a plurality of the connecting pipes 13 and introduced into the fuel flow channels 11 of the respective separators 8, and discharged from fuel gas discharge openings 11a in the ends of the flow channels. The discharged fuel gas is fed through the through-hole 50a of the reforming catalyst layer 50 to the fuel-electrode current collector 41 facing the separator.

Reforming reaction is performed while the fuel gas repeatedly contacts with the reforming catalyst layer 50 adjacent to the lower part of the fuel-electrode current collector 41 in the process of diffusing and transferring from the central part to the peripheral part in the fuel-electrode current collector 41.

Reforming reaction in the fuel-electrode current collector 41 is as mentioned before, and its explanation is omitted here; the methane gas in the fuel gas is reformed into hydrogen and carbon monoxide through reforming reaction. The hydrogen-rich reformed gas reaches the fuel-electrode layer 3 of the power generating cell 5 from the fuel-electrode current collector 41, and reacts with Ni, etc. on the fuel-electrode layer 3, whereby reforming reaction occurs again.

Thus, the reforming catalyst layer 50 composed of the porous metal body 51 according to the embodiment functions mainly as a carrier of the hydrocarbon reforming catalyst particles 52, not as a flow path for the fuel gas, and the fuel-electrode current collector 41 composed of the porous sintered metal plate located on the reforming catalyst layer 50 functions as the gas flow path.

Therefore, since the hydrocarbon reforming catalyst particles 52 to obstruct the flow of the fuel gas are not at all disposed in the flow part of the fuel gas, a gas flow path having invariably good flowing is secured in the fuel cell stack 1 without being influenced by loading amount of the hydrocarbon reforming catalyst particles 52. In other words, this structure allows a sufficient amount of the hydrocarbon reforming catalyst particles 52 to be disposed in the fuel cell stack 1.

Besides, since the hydrocarbon reforming catalyst particles 52 is disposed between the separator 8 and the fuel-electrode current collector 41, where the temperature is highest in the fuel cell stack 1, in the state that the hydrocarbon reforming catalyst particles 52 are loaded in the porous metal body 51 composed of Ni, etc. excellent in thermal conductivity, even if the present invention is applied to a fuel cell module 40 to operate at a low operating temperature, about 700° C., the porous metal body 51 efficiently absorbs the heat in the stack, and the optimal reforming temperature range (650 to 800° C.) is secured, which shifts the equilibrium depending on the power output (consumption amount of the fuel gas), whereby the reforming catalyst layer 50 always provides an excellent reforming capability.

As a result, even if the insufficiently reformed fuel gas containing much methane is fed to the fuel cell stack 1 from the reformer 45 installed in an atmosphere where the temperature in the fuel cell module 40 is about 600° C., this reforming mechanism in the stack reforms the unreformed fuel gas into a hydrogen-rich fuel gas before the unreformed gas reaches the fuel-electrode layer 3.

Thereby, the carbon deposition due to the unreformed gas can be avoided, and an efficient and stable internally-reforming power generation becomes possible.

What is claimed is:

1. A solid oxide fuel cell comprising: a fuel-electrode layer and an air-electrode layer disposed on both surfaces of a solid electrolyte layer; a fuel-electrode-side porous metal and an air-electrode-side porous metal disposed on the outer sides of the fuel-electrode layer and the air-electrode layer, respectively; and a separator disposed on each of the outer sides of the fuel-electrode-side porous metal and the air-electrode-side porous metal, all said components being closely adhered to each other, wherein the interior of pores of the fuel-electrode-side porous metal is partially or fully filled with a hydrocarbon reforming catalyst, and reforming reaction is driven by the hydrocarbon reforming catalyst before a fuel gas reaches the fuel-electrode layer.

2. The solid oxide fuel cell according to claim 1, wherein the fuel-electrode-side porous metal has a three-dimensional skeletal structure, and the pores formed by the skeleton have a near-spindle shape of 80 to 800 μm in the average pore size.

3. The solid oxide fuel cell according to claim 1, wherein the hydrocarbon reforming catalyst is composed of particles in which an active metal component selected from the group consisting of nickel, palladium, ruthenium, platinum, rhodium, copper and combinations thereof is loaded on a ceramic carrier, and the average particle size of the particles is 10 to 60% of the pore size of the fuel-electrode-side porous metal.

4. The solid oxide fuel cell according to claim 1, wherein the fuel-electrode-side porous metal is constructed by integrally laminating at least one sheet of a porous metal filled with the hydrocarbon reforming catalyst and at least one sheet of a porous metal filled with no catalyst.

5. The solid oxide fuel cell according to claim 1, wherein the fuel-electrode-side porous metal is constructed by filling a porous metal plate having a three-dimensional skeletal structure with a hydrocarbon reforming catalyst and then pressing the porous metal plate.

6. The solid oxide fuel cell according to claim 1, wherein when the interior of the pores of the fuel-electrode-side porous metal is filled with the hydrocarbon reforming catalyst, a larger amount of the reforming catalyst is filled downstream of a fuel gas than upstream thereof.

7. The solid oxide fuel cell according to claim 1, wherein the fuel-electrode-side porous metal body for supporting the hydrocarbon reforming catalyst is composed of nickel, a nickel-based alloy, iron, or an iron-based alloy.

8. A solid oxide fuel cell comprising at least one power generating cell in which a solid electrolyte layer is disposed between a fuel-electrode layer and an air-electrode layer, the fuel-electrode layer containing a material to promote reforming reaction of a fuel gas, wherein a porous metal is disposed adjacent to the fuel-electrode layer and supports a reforming catalyst composed of the catalytically active material of the fuel-electrode layer, and reforming reaction is driven by the reforming catalyst before the fuel gas reaches the fuel-electrode layer.

9. The solid oxide fuel cell according to claim 8, wherein the porous metal is a fuel-electrode current collector disposed adjacent to the fuel-electrode layer.

10. The solid oxide fuel cell according to claim 8, wherein the porous metal body for supporting the hydrocarbon reforming catalyst is composed of nickel, a nickel-based alloy, iron, or an iron-based alloy.

11. The solid oxide fuel cell according to claim 8, wherein the fuel-electrode layer is formed of a composite material of Ni, Pd, Ru, Pt, Rh, Cu or combination thereof and a ceramic, the ceramic being one selected from (Ce_{0.8}·Sm_{0.2})O₂, (La_{0.8}·Sr_{0.2}) (Ga_{0.8}·Mg_{0.15}·Co_{0.05})O₃, or ZrO₂ doped with Y₂O₃ of 3 to 8 mol %.

12. The solid oxide fuel cell according to claim 11, wherein the reforming catalyst is a mixture of a particulate powder of Ni, Pd, Ru, Pt, Rh, Cu or combination thereof and a particulate powder of the ceramic, both materials of which form the fuel-electrode layer, their particle sizes being 10 μm or less.

13. A solid oxide fuel cell comprising: a fuel-electrode layer and an air-electrode layer disposed on both surfaces of a solid electrolyte layer; a fuel-electrode current collector and an air-electrode current collector, both composed of a porous metal, disposed on the outer sides of the fuel-electrode layer and the air-electrode layer, respectively; and a separator disposed on each of the outer sides of the fuel-electrode current collector and the air-electrode current collector, a fuel gas and an oxidant gas being fed from the separators through the fuel-electrode current collector and the air-electrode current collector to the fuel-electrode layer and the air-electrode layer, respectively, wherein the interior of the fuel-electrode current collector is partially or fully filled with a hydrocarbon reforming catalyst, a larger amount of the reforming catalyst being filled downstream of the fuel gas than upstream thereof.

14. The solid oxide fuel cell according to claim 13, wherein the solid oxide fuel cell has a structure in which the fuel gas and the oxidant gas are fed from the central parts of the separators through the fuel-electrode current collector and the air-electrode current collector to the fuel-electrode layer and the air-electrode layer, respectively, and a larger amount of the hydrocarbon reforming catalyst is loaded in the peripheral part of the fuel-electrode current collector than in the central part thereof.

15. The solid oxide fuel cell according to claim 13, wherein the porous metal has a three-dimensional skeletal structure.

16. A solid oxide fuel cell comprising: a fuel-electrode layer and an air-electrode layer disposed on both surfaces of a solid electrolyte layer; a fuel-electrode current collector and an air-electrode current collector, both composed of a porous metal, disposed on the outer sides of the fuel-electrode layer and the air-electrode layer, respectively; and a separator disposed on each of the outer sides of the current collectors, reactant gases being fed from the separators through the current collectors to the fuel-electrode layer and the air-electrode layer, respectively, wherein a hydrocarbon reforming catalyst is disposed between the separator and the fuel-electrode current collector.

17. The solid oxide fuel cell according to claim 16, wherein the hydrocarbon reforming catalyst is loaded in a porous metal body.

18. The solid oxide fuel cell according to claim 17, wherein the porous metal body for supporting the hydrocarbon reforming catalyst is composed of nickel, a nickel-based alloy, iron, or an iron-based alloy.

19. The solid oxide fuel cell according to claim 17, wherein the porous metal body for supporting the hydrocarbon reforming catalyst is provided with a through-hole penetrating from a reactant gas discharging part of the separator to the fuel-electrode current collector side.
